(19) United States
(12) Patent Application Publication
(10) Pub. No.: US 2005/0131892 A1
(43) Pub. Date: Jun. 16, 2005

(54) Natural language web site interface

(75) Inventors: Benjamin A. Knott, Round Rock, TX (US); Robert R. Bushey, Cedar Park, TX (US); Theodore B. Pasquale, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SBC Knowledge Ventures, L.P., Reno, NV (US)

(21) Appl. No.: 10/732,397

(22) Filed: Dec. 10, 2003

(51) Int. Cl. G06F 17/30

(52) U.S. Cl. 707/5

(57) ABSTRACT

A method and system for providing a natural language web site interface. A visitor to the web site (typically a customer to a commercial web site) is prompted to enter a natural language query. The query is interpreted and associated with content for that web site, which is then downloaded to the user.

### TECHNICAL FIELD OF THE INVENTION

This invention relates to providing information over the Internet, and more particularly to providing user interfaces for web sites.

### BACKGROUND OF THE INVENTION

Web site designers spend considerable time designing web sites that will best match the majority of customer's mental processes. The design process is difficult, expensive, and error prone.

The majority of today's consumer web sites are designed according to a web browsing navigation model in which users select hyperlinks from a navigation menu, a list, or embedded in text. For a customer with a specific task (e.g., finding the price for caller ID on a telephone services website), the customer must peruse web pages for a succession of links that match his or her understanding of the task. Thus, for example, to obtain caller ID pricing information, a customer first selects a “residential customer” link, then a “products and services” link, then a “phone features” link, and finally a “caller ID” link.

Even in the best web designs, there may be opportunities for the customer to follow incorrect link paths. In addition, when there are many options, lists of options may be lengthy. These conditions often lead to customer frustration and abandonment of the web site.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a method of providing a natural language web site interface in accordance with the invention.

FIG. 2 illustrates a client-server web access system for implementing the method of FIG. 1.

FIG. 3 illustrates action-object pairs used to match natural language queries to web content.

FIG. 4 illustrates how the action-object database of FIG. 1 is created.

### DETAILED DESCRIPTION OF THE INVENTION

The invention described herein is directed to a method and system for providing a natural language web site interface. The interface provides a new approach for web site navigation, in which customers can simply query the web site using familiar words and phrases. The interface is typically used with a commercial web site, accessed by customers needing information and/or purchasing services and/or goods, but the same concepts could be applied for use with any type of web site.

The web interface makes use of two technologies that are conventionally applied for speech recognition for IVR (interactive voice response) systems, such as are used to implement customer call centers. These two technologies are natural language understanding (NLU) and statistical language modeling (SLM).

Natural language understanding is often categorized as a sub-field of artifical intelligence. It is directed to making computers “understand” statements written in human languages. When applied to interactive voice response systems, this task involves accurately transforming human speech into machine-readable text, analyzing the text's vocabulary and structure to extract meaning, generating a sensible response, and replying in a human-sounding voice. Natural language understanding permits persons interacting with a speech system to escape the constraints of a narrow range of expressions spoken in a halting voice. Rather, with natural language understanding, the system can recognize and understand complex expressions that are spoken in a natural manner.

Natural language understanding may be used in conjunction with statistical language modeling (SLM). An SLM system is developed by processing a large number of human utterances. These utterances are used to derive a statistical model that permits the speech system to extract meaning from a wide range of speech inputs.

An example of a voice-based application of SLM is in telephone call routing applications for call centers. Voice callers are directed to a correct destination by interpreting their natural language requests. For example, rather than being prompted to make selections from a menu or list, an SLM system might simply prompt a customer with “what would you like to do”? The customer may respond with an answer such as “I have a billing question”. The system then routes the customer to an appropriate destination associated with the call center.

For purposes of the present invention, NLU and SLM techniques are applied to a web site accessed via the Internet. As explained below, customers who visit the web site enter, in natural language text, the task he or she desires to perform while visiting the web site. No speech recognition is required.

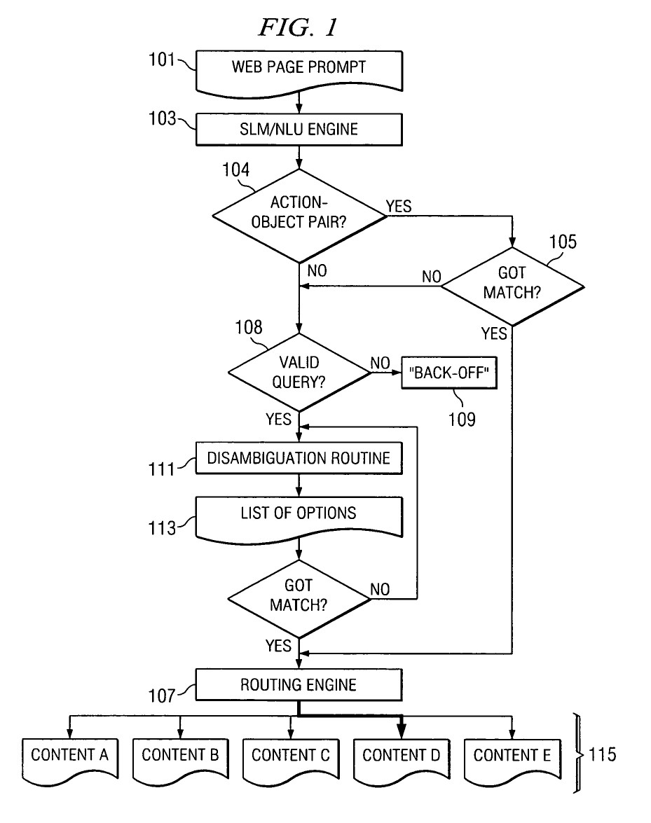

FIG. 1 illustrates a method of providing a natural language web interface in accordance with the invention. It is assumed that the customer has accessed a web site, such as by entering a web site address to the customer's web browser or accessing the web site by means of a web search engine.

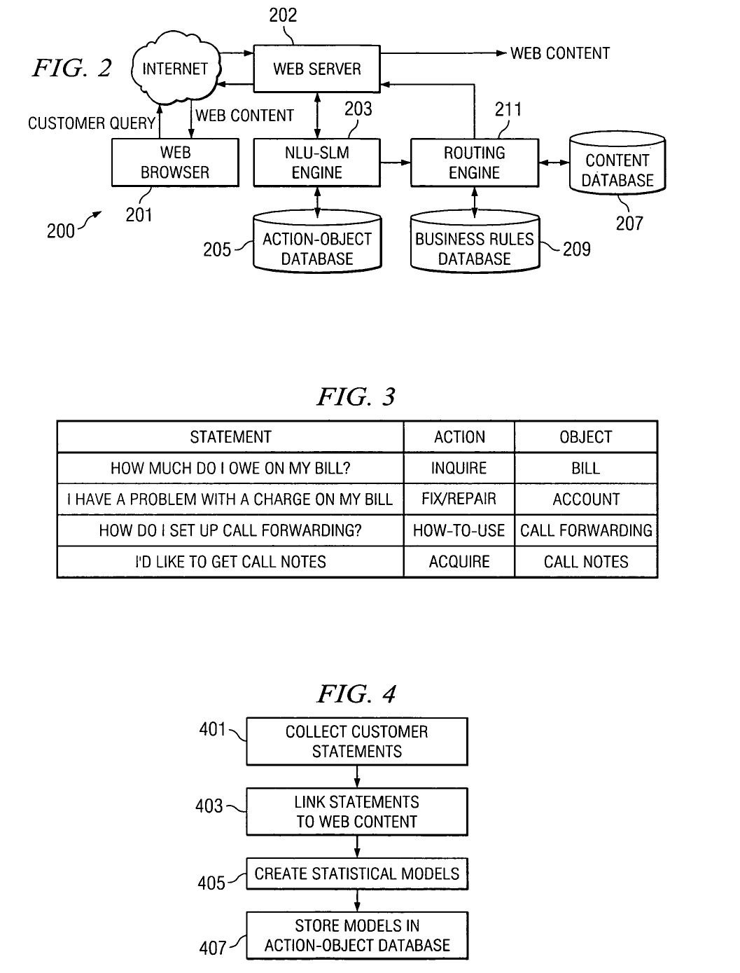

FIG. 2 illustrates a natural language interface system 200 for implementing the method of FIG. 1. System 200 is essentially an Internet-enabled client-server system, comprising computing equipment and data storage devices, programmed to implement the method of FIG. 1.

More specifically, the customer uses a client system 201 equipped with a web browser and appropriate input and output devices. The client system 201 may be a personal computer or any other type of web access device.

Server 202 communicates with the client via the Internet, providing web content and working in conjunction with NLU/SLM engine 203. Server 202 provides a web interface, such as through a merchant web site, and communicates with the customer via the customer's web browser.

Referring to both FIGS. 1 and 2, in Step 101, server 202 presents the customer with a home page or other greeting page. This page contains an open-ended question with a text field, in which the customer will enter his or her response. The prompt for input is designed to encourage a natural language response. The customer's natural language response is referred to herein as the “customer query”.

For example, the home page might prompt the customer with the question: “Please enter the reason for your visit here today”. A typical customer query might be: “I'm just shopping around. How much does Caller ID cost?”

In Step 103, the server 202 receives the query and sends it to SLM/NLU engine 203 for processing. Engine 203 interprets the textual input so that it can be associated with appropriate web site content.

A feature of the invention is that engine 203 attempts to interpret each customer's natural language query as an action-object pair. In other words, it is assumed that the customer desires some sort of service (an action) relating to some sort of subject matter (the object).

FIG. 3 illustrates examples of action-object pairs. As illustrated, examples of actions are: inquire, fix/repair, how-to-use, and acquire. Examples of objects are: bill, account, call forwarding, and call notes. In practice, an actual web site is likely to have hundreds of actions and objects.

Referring again to FIGS. 1 and 2, action-object database 205 stores a set of action-object pairs. Each action-object pair is indexed or otherwise linked to associated web content. Content database 207 stores a set of content selections for the particular web site of interest. Thus, the action-object pairs in database 205 have associated web content stored in database 207.

As stated above, in Step 103, NLU/SLM engine 203 interprets queries as action-object pairs (Step 104), which are indexed or otherwise matched (Step 105) to an address to web site content in database 207.

In Step 107, routing engine 211 receives the results of the interpretation from NLU/SLM engine 203 and accesses database 207 to retrieve the content. For example, the appropriate content might be a web page with pricing information for Caller ID. Routing engine 211 then routes that content to server 202 for download to the customer.

A business rules database 209 stores business rules, which may also be associated with action-object pairs. Once a customer's query is interpreted as an action-object pair, routing engine 211 accesses database 209 to determine whether one or more business rules specify additional content to be delivered to that customer.

As an example, suppose the method of FIG. 1 indicates that when a customer's query contains the words “set”, “up”, and “call notes”, there is a 90% probability that this statement is matched to a “Setup—CallNotes” action-object pair. This probability exceeds an ambiguity threshold, and thus the content associated with that action-object pair may be confidently delivered to the customer.

As stated above, the content may include content that is the result of application of business rules, in addition to content that directly addresses the action-object pair. For example, a business rule could be associated with a “Setup—Call Notes” action-object pair, such that web content for services related to Call Notes is presented in addition to the Setup Call Notes content. Thus, when a customer enters “How do I set up my Call Notes service?”, he or she is presented with the appropriate instructions as well as additional information on additional services related to Call Notes.

Links labeled “Related Topics” could also be presented as the result of application of business rules. The business rules might specify that lower probabilities shall result in certain content or links.

Steps 109-113 are performed if the interpreting steps (Steps 103-105) fail to obtain a match between an action-object pair and content. If the query is invalid (Step 108), a back-off step (Step 109) returns the customer to a conventional web site menu navigation.

If Step 108 determines that the query is valid, it is “disambiguated.” An ambiguous query could occur, for example, if a probability threshold is not met. In this case, Step 111 attempts to disambiguate the query by offering options to clarify the original query input.

For example, an ambiguous query would be if the customer typed “I would like to find out how much a service costs”. Step 111 would be performed by displaying a list of services and the message “Select the service for which you need pricing from the list below”. The customer is then presented with links that are relevant to his or her query. In effect, system 200 responds to “partial understanding” of the natural language query.

As another example of disambiguation, a customer might simply type “billing” as his or her natural language query. Engine 203 interprets the query as an object without an action. The statement is ambiguous because there is no action. Nevertheless, engine 203 instructs server 202 to present the customer with a prompt for more information. For example, server 202 might present the customer with the prompt “What about billing? Would you like to . . . ”, followed by a menu or list of links representing possible actions. The user would then select the appropriate option, completing the action-object pair, and server 202 would then present the user with the appropriate content from database 205.

As another example, the customer's natural language query might be interpreted as only an action. The customer might enter “I want to learn how to use my phone services”. Engine 203 interprets the query as an action without an object, and instructs server 202 to prompt the user with “What service do you need information about?” followed by a list of options.

In general, all possible action-object combinations are stored in database 205. As a result, for a given action or a given object, engine 203 can determine all available options.

Step 115 is displaying the content to the customer. From the customer's point of view, after being presented with the greeting page in Step 101, the customer is next presented with the desired information, rather than being required to navigate through a series of menu selections. The customer is presented with specific content, not a list of links.

The above-described method differs from conventional natural language web search methods. It provides a new approach to web site navigation within a web site, which shifts the focus from menu-driven browsing to a task-driven natural language dialog. In response to natural language query, the user is next presented with web site content, rather than links to content.

The natural language interface need not entirely replace the browsing interface—rather, the two types of interfaces complement each other. The natural language interface may be used as the primary navigation method for a web site, with links and menus offered as secondary navigation. The customer may select the navigation method that best matches his or her preferences.

FIG. 4 illustrates the process of creating the action-object database 205. Action-object pairs are derived from a data collection effort in which natural language statements are associated with action-object pairs in terms of probabilities.

In Step 401, natural customer statements are collected. The collection process can be by collecting customer activity for the web site in question, prior to implementation of the natural language interface. As explained below, customer goals and activities are modeled as “action-object” pairs.

In Step 403, customer statements are matched to appropriate web content. This step can be performed manually or automatically.

In Step 405, the customer statements and matching web content are used to create statistical models. For each query from a customer, there is a probability that the query corresponds to an action-object pair. As indicated above, low probability matches (those under a certain threshold) can be accompanied by disambiguation techniques.

In Step 407, the statistical models are integrated into a web interface. The models are stored in database 205, which is accessible by engine 203, which selects and forwards appropriate content to server 202.

1. A method of providing web site content to a user of a web browser, comprising the steps of:
storing a set of action-object pairs;
storing a set of web site content selections;
storing a set of business rules;
displaying, on the user's web browser, a prompt for a textual natural language query;
receiving the query at a web server;
interpreting the query as one of the action-object pairs, wherein the interpretation is based on a probability that the query is represented by an action-object pair, such that if the probability does not exceed a threshold the interpretation is invalid or ambiguous;
if the interpretation is invalid, providing the user with menu navigation options;
if the interpretation is ambiguous, prompting the user for additional natural language input;
if the interpretation exceeds the threshold, associating the results of the interpreting step to web site content; retrieving the associated web site content;
and downloading the associated web site content to the web browser.

2. A method of providing web site content to a user of a web browser, comprising the steps of:
storing a set of actions and objects;
storing a set of web site content selections;
displaying, on the user's web browser, a prompt for a textual natural language query;
receiving the query at a web server;
interpreting the query as at least one of the following: an action or an object;
associating the results of the interpreting step with web site content;
retrieving the associated web site content; and
downloading the associated web site content to the web browser.

3. The method of claim 1, wherein the query is interpreted as an action, and further comprising the step of presenting the user with a list of object options.

4. The method of claim 1, wherein the query is interpreted as an object, and further comprising the step of presenting the user with a list of action options.

5. The method of claim 1, wherein the query is interpreted as an action-object pair.

6. The method of claim 1, further comprising the step of storing a set of business rules, and further comprising the step of associating the results of the interpreting step with one or more business rules.

7. The method of claim 1, wherein the interpretation is performed by determining a probability that the query is represented by an action-object pair.

8. The method of claim 7, further comprising the step of determining whether the probability exceeds a threshold.

9. The method of claim 7, wherein the probability is less than a threshold, and further comprising the step of presenting the user with a list of further options.

10. A system for providing web site content to a user of a web browser, comprising:
a database for storing a set of actions and objects;
a database for storing a set of web site content selections;
a server for displaying, on the user's web browser, a prompt for a textual natural language query, and for receiving the query at a web server; and
a natural language engine for interpreting the query as at least one of the following: an action or an object; for associating the results of the interpreting step to web site content; and
a routing engine for retrieving the associated web site content and delivering the associated web site content to the server;
wherein the server is further operable to download the associated web site content to the web browser.

11. The system of claim 10, wherein the query is interpreted as an action, and wherein the server further presents the user with a list of object options.

12. The system of claim 10, wherein the query is interpreted as an object, and wherein the server further presents the user with a list of action options.

13. The system of claim 10, wherein the query is interpreted as an action-object pair.

14. The system of claim 10, further comprising a database for storing a set of business rules, and wherein the engine further matches the results of the interpreting step to one or more business rules.

15. The system of claim 10, wherein the engine performs the interpretation by determining a probability that the query is represented by an action-object pair.

16. The system of claim 15, wherein the engine further determines whether the probability exceeds a threshold.

17. The system of claim 15, wherein the probability is less than a threshold, and wherein the server further f presents the user with a list of further options.

18. The system of claim 10, wherein the natural language engine may further interpret the query as an invalid query.

19. The system of claim 17, wherein the server presents the user with a back-off navigation interface in response to an invalid query.
